(19) United States
(12) Patent Application Publication
(10) Pub. No.: US 2008/0235186 A1
(43) Pub. Date: Sep. 25, 2008

(54) Lawful Interception of Search Functionalities

(76) Inventor: Antti Laurila, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/690,338

(22) Filed: Mar. 23, 2007

(51) Int. Cl. G06F 17/30; G06F 7/00

(52) U.S. Cl. 707/3; 707/4

(57) ABSTRACT

A method, a computer program product, apparatuses and a system are shown for performing Lawful Interception of Search Functionalities, by extracting at least one search related information from a search message in a communication system, wherein the search message is based on a query programming language and is associated with a search requester, and wherein the search message is one out of a search request and a search response, and determining whether at least one of the at least one search related information represents information to be intercepted, and sending at least one of the at least one search related information to a law enforcement agency in case at least one of the at least one search related information represents information to be intercepted.

### FIELD OF THE INVENTION

This invention relates to a method, a computer program product, apparatuses and a system for performing Lawful Interception of Search Functionalities in a communication system.

### BACKGROUND OF THE INVENTION

The Open Mobile Alliance (OMA) has defined a generic framework for Extensible Markup Language (XML) Document Management (XDM). The XDM defines a common mechanism that makes user-specific service-related information accessible to the service enablers that need them. Such information is expected to be stored in the network where it can be located, accessed and manipulated (e.g. created, changed, deleted).

XDM specifies how such information will be defined in well-structured XML documents, as well as the common protocol for access and manipulation of such XML documents. The XML Configuration Protocol (XCAP), as defined by the Internet Engineering Task Force (IETF), has been chosen as the common XML Document Management protocol.

The XDM Core Specification version 2.0 defines three main features:
The common protocol, XML Configuration Access Protocol (XCAP), by which principals can store and manipulate their service-related data, stored in a network as XML documents.
The Session Initiation Protocol (SIP) subscription/notification mechanism by which principals can be notified of changes to such documents.
The extensions to the XCAP, by which principals can search service-related data stored in a network as XML documents using limited XML Query Language (XQuery).

FIG. 1 shows a typical XDM framework 100. Documents accessed and manipulated via XCAP are stored in logical repositories in the network, called XML Document Management Servers (XDMS). There are two types of XDMSs: Shared XDMS 130 and Enabler Specific XDMS 140. Shared XDMSs 130 are repositories to be used by a plurality of service enablers. Enabler Specific XDMSs 140 are enabler-specific, and their information is used by corresponding enabler specific servers 150.

An XDM Client 110 is able to access and manipulate XML documents by using XCAP protocol. The XDM Client 100 has a single contact point for XCAP requests via an XDM-3 interface, namely an Aggregation Proxy 120. Accordingly, a transmitted XCAP request first passes via the XDM-3 interface to Aggregation Proxy 120, and then the Aggregation Proxy 120 authenticates and routes the received XCAP request to a correct XDMS 130,140. The Aggregation Proxy 120 also forwards the response back to the XDM Client 110.

XDM Core Specification version 2.0 has introduced a new network element called Search Proxy 170, which is the single contact point for the XDM Client via an XDM-5 interface to search XML documents stored in any XDMS Servers 130,140. The Search Proxy 170 performs forwarding search requests from XDM Clients 110 (XDM-5) to the corresponding XDM Servers 130,140 that store the targeted XML document via an XDM-6 interface and also to other networks when needed.

Further, the Search Proxy 170 receives search responses from XDM Servers 130,140 (XDM-7) and also from other networks when needed, and the Search Proxy 170 aggregates search results from XDM Servers 130,140 (XDM-6) as appropriate and then forwards those back to the XDM Clients 110 through the Aggregation Proxy via the XDM-5 interface.

The protocol for the XDM-5 and XDM-6 interfaces is Limited XQuery over OMA-extended XCAP. Accordingly, the search requests and the search responses are based on an XQuery language, wherein said XQuery language allows queries to XML type of data, e.g. selecting elements and attributes based on specific criteria, and/or joining data from multiple documents and/or sorting results, and defining the returned elements and format of the results.

In addition to the mentioned XDM-3, XDM-5, XDM-6 and XDM-7 interfaces, the XDM framework has other defined interfaces: an XDM-1 interface between the XDM client 110 and network core 160, an XDM-2 interface between the shared XDMS 130 and the network core 160 and an XDM-4 interface between the aggregation proxy 120 and the shared XDMS 130. The network core 160 corresponds to the part of the IP (Internet Protocol) based or other network though which service-related signaling, such as SIP (Session Initiation Protocol) and/or GPRS signaling (GPRS), and payload is communicated. Dashed lines in FIG. 2 indicate enabler-specific reference points for communication.

There may be circumstances in which authorized agencies such as law enforcement agencies (LEA's), e.g. the police and/or intelligence services, must be able to monitor telecommunication traffic. Such lawful interception may, for instance, be required for collection information on those suspected of involvement in criminal or terrorist activities. The term “lawful interception” means an action, authorized by law and performed by a network operator, access provider and/or service provider (hereinafter referred to as an operator), whereby certain information is made available and provided to a law enforcement monitoring facility (LEMF) associated with a LEA. The term “law enforcement monitoring facility” (LEMF), in turn, means a law enforcement facility designated as the transmission destination for the results of lawful interception activity relating to a particular interception subject. The term “interception subject” means a person or persons, specified in a lawful authorization, whose telecommunications are to be intercepted.

The block diagram depicted in FIG. 2 shows a conventional system 200 for performing lawful interception. The prior-art system comprises devices and functions both within the domain of an operator and within the domain of law enforcement agencies (LEA). The law enforcement monitoring facility (LEMF) 210 communicates with the operator domain via the lawful interception handover interface, i.e. the HI interface. The handover interface is a physical and logical interface across which interception measures are requested from the operator domain and the results are delivered by the operator domain to LEMF 210.

LEMF 210 communicates with the operator's administration function 230 via handover interface port 1 (HI1). By communicating with the administration function 230, LEMF 210 can place persons under surveillance and remove persons from surveillance.

LEMF 210 communicates with an IRI (intercept related information) mediation function 240 via handover interface port 2 (HI2). From IRI mediation function 240, LEMF 210 receives information or data associated with telecommunication services, other than the actual payload. This information or data may involve a target identity, specifically communication-associated information or data (e.g. unsuccessful communications attempts), service-associated information or data and location information.

LEMF 210 communicates with a CC (content of communication) mediation function 250 via handover interface port 3 (HI3). From CC mediation function 250, LEMF 210 receives the actual content of communication (payload, user data). By definition, content of communication means information exchanged between two or more users of a telecommunications service (e.g. speech, data), excluding intercept related information. This includes information that may, as part of some telecommunications service, be stored by one user for subsequent retrieval by another.

This IRI mediation function 240 typically obtains the intercepted-related information and the CC mediation function 250 obtains the content of communication to be sent to the LEMF 210 from the network's internal functions 220. The network's internal functions 220 may specifically provide an internal intercepting function (IIF), which is a point within a network or network element at which the content of communication (CC) and the intercept-related information (IR) are made available. The IRI and CC are sent to mediation functions 240 and 250 via an internal network interface (INI) or similar apparatus.

In the XDM framework depicted in FIG. 1, data content transmitted between a XDM client 110 and a XDMS 130,140 by means of XCAP may be intercepted in the Aggregation Proxy 120, and this XCAP traffic may be transmitted from the Aggregation Proxy 120 via the handover interface 3 (HI3) to a LEMF 210 in order to be intercepted.

As the general requirement for lawful interception is that all telecommunication traffic and information needs to be interceptable, then it should be possible to intercept also XDM Search, i.e. what data certain user searches from XDM documents stored in the network (XDM Servers 130,140) and what data is included in the search response.

Contrary to the XCAP traffic, the XDM Search functionality can not be intercepted in the Aggregation Proxy 120 as it does not understand XQuery protocol. The Aggregation Proxy 120 only authenticates a user and forwards a search request to the Search Proxy 170, but it cannot be used for XDM Search functionality as the Aggregation Proxy 120 does not understand (e.g. parse and form) XQuery sentences of the XQuery language.

### SUMMARY

A method is disclosed, comprising extracting at least one search related information from a search message in a communication system, wherein said search message is based on a query programming language and is associated with a search requester, and wherein said search message is one out of a search request and a search response, said method further comprising determining whether at least one of said at least one search related information represents information to be intercepted, and sending at least one of said at least one search related information to a law enforcement agency in case at least one of said at least one search related information represents information to be intercepted.

Furthermore, a computer-readable medium having a computer program stored thereon is disclosed. The computer program comprises extracting at least one search related information from a search message in a communication system, wherein said search message is based on a query programming language and is associated with a search requester, and wherein said search message is one out of a search request and a search response, and it comprises determining whether at least one of said at least one search related information represents information to be intercepted, and sending at least one of said at least one search related information to a law enforcement agency in case at least one of said at least one search related information represents information to be intercepted.

Furthermore, a computer program is disclosed, comprising instructions operable to cause a processor to extract at least one search related information from a search message in a communication system, wherein said search message is based on a query programming language and is associated with a search requester, and wherein said search message is one out of a search request and a search response, and to determine whether at least one of said at least one search related information represents information to be intercepted, and to send at least one of said at least one search related information to a law enforcement agency in case at least one of said at least one search related information represents information to be intercepted.

Furthermore, an apparatus is disclosed, comprising a processing component configured to extract at least one search related information from a search message in a communication system, wherein said search message is based on a query programming language and is associated with a search requester, and wherein said search message is one out of a search request and a search response, and to determine whether at least one of said at least one search related information represents information to be intercepted, and to send at least one of said at least one search related information to a law enforcement agency in case at least one of said at least one search related information represents information to be intercepted.

Furthermore, a system is disclosed, comprising said apparatus, and comprising at least one interface configured to connect at least one user to said system and comprising at least one interface configured to communicate with a law enforcement agency.

Furthermore, an apparatus is disclosed, comprising means for extracting at least one search related information from a search message in a communication system, wherein said search message is based on a query programming language and is associated with a search requester, and wherein said search message is one out of a search request and a search response, and comprising means for determining whether at least one of said at least one search related information represents information to be intercepted, and comprising means for sending at least one of said at least one search related information to a law enforcement agency in case at least one of said at least one search related information represents information to be intercepted.

According to the method, computer program product, computer program, apparatus and system of the present invention, lawful interception can be applied to search functionalities in a communication system, wherein search messages, e.g. a search request and/or a search response, are based on a query programming language.

The search message may be used to perform search functionalities in a communication system. E.g., said search message may represent a search request received from a search requester, e.g. a user client or a user or any other requester, wherein said search request is intended to perform a search into content or information stored or being accessible in said communication system. Said content or information may be stored in at least one storage entity. For instance, said at least one storage entity may be at least one logical repository in the network and/or at least one physical repository in the network. E.g., in case the communication system represents a group and list communication system like an XML Document Management system, then said at least one storage entity may be at least one XML document management server (XDMS).

Furthermore, the search message may represent a search response. For instance, this search response may be intended to be transmitted to a search requester, e.g. a user client or a user or any other requester, after a search has been performed, wherein the search response contains the results of the conducted search.

The search message, i.e. the search request or the search response, is based on a query programming language. For instance, said query programming language may be one language out of SQL, MDX for OLAP (Online Analytical Processing) databases, DMX for Data Mining models and XQuery, which may depend on the communication system. Furthermore, the query programming language may be any other suited query language suited for search into databases and/or information systems.

For instance, said query programming language may allow queries to type of data, e.g. selecting elements and attributes based on specific criteria, and/or joining data from multiple documents and/or sorting results, and defining the returned elements and format of the results.

For instance, a search request may be received in the communication system from a search requester. E.g. this search request may be received via a network element which provides at least one contact point for clients or user of the communication system. Said network element may further be configured to communicate with a client or a user in order to transmit and/or receive content to/from said client or a user, e.g. content to be stored in at least a storage entity or content transmitted from at least one storage entity to the client or user. Said transmission of content may be based on a protocol being different from the protocol used for search messages like search requests or search responses. E.g., in case the method is applied to the group and list communication system, e.g. an XML document management system, then the XCAP protocol may be used for transmitting content via a first contact point, and XQuery based on the XQuery programming language may be used for transmitting search messages via a second contact point. For instance, said network element may represent an aggregation proxy of a group and list communication system.

Furthermore, the search may be performed by a network search element in said communication system. For instance, said network search element may represent a search proxy.

After receiving the search request, at least one search related information is extracted from said search message. Said extraction is based on the query programming language in order to parse the language and to extract the search related information from the search request. Thus, said extracting may be performed by a parsing unit corresponding to the applied query programming language. For instance, any search related information contained in a search request is extracted.

This search related information may be at least one out of search requester information and at least one search criteria. The search requester information may contain information about the search requester identity, e.g. a user identification. Said at least one search criteria may contain any information for performing the search in the communication system, e.g. special data to be searched and/or special data repositories to be searched and/or any other search criteria.

Based on the extraction of this search related information, it is determined whether at least one of said at least one search related information represents information to be intercepted. This determining may be based on rules given by a lawful authorization in order to perform lawful interception.

In case at least one of said at least one search related information represents information to be intercepted, then at least one of said at least one search related information is sent to a law enforcement agency. This sending may be performed by an interface, wherein this interface is configured to communicate with a corresponding law enforcement agency. For instance, said interface is configured to communicate with a law enforcement monitoring facility associated with said law enforcement agency.

Thus, it is determined whether the search request is to be intercepted, and based on this determining, at least one of said search related information is sent to a law enforcement agency. For instance, the whole search response may be transmitted to the law enforcement agency in case that at least one of said at least one search related information represents information to intercepted.

The aforementioned explanations regarding the search request also hold for a search response. This search response may be transmitted to a search requester after a search has been conducted, e.g. based on a preceding search request. This search response contains content of response of said conducted search and is also based on the query programming language.

Based on the query programming language, at least one search related information is extracted from the search response. This search related information may be at least one out of a search requester information and at least one search content representative. The search requester information may contain information about the search requester identity, e.g. a user identification. The at least one search content representative may contain any content of the search response, e.g. data that has been found based on the search or data identifiers.

After said at least one search related information has been extracted, it is determined whether at least one of said at least one search related information represents information to be intercepted. As mentioned above, this determining may be based on rules given by a lawful authorization.

For instance, there may be a first set of rules for search requests and a second set of rules for search responses.

In case at least one of said at least one search related information represents information to be intercepted, then at least one of said at least one search related information is transmitted to a law enforcement agency. This transmitting may be performed as explained above with respect to the search request. For instance, the whole search response may be transmitted to the law enforcement agency. Further, for instance, in case that the corresponding search request is available, then this corresponding search request may also be transmitted to the law enforcement agency along with the corresponding search response.

The present invention allows checking whether a search message based on a query programming language, e.g. a search request or a search response based on a query programming language, is to be intercepted. This checking can not be performed by network elements that do not understand the query programming language. Since a lot of communication systems use a protocol for transferring content being different from a query protocol, wherein this query protocol uses a query programming language, the checking whether a search message based on a query programming language is to be intercepted can not be performed by network elements which are only capable to apply the content transfer protocol, e.g. the XCAP protocol used in a group communication system. The present invention overcomes this problem, since it allows extracting the search related information from the search message based on the query programming language, e.g. an XQuery language used in a group and list communication system. For instance, this XQuery may be Limited XQuery over OMA-extended XCAP, which allows search of information from XML documents stored in any XMDS.

Accordingly, lawful interception can be applied to search messages based on a query programming languages due to the present invention, and the general requirement for lawful interception that all telecommunication traffic and information needs to be interceptable can be achieved with the present invention.

According to an exemplary embodiment of the present invention, said search message is a search request and said at least one extracted search related information is at least one out of search requester information and at least one search criteria.

For instance, said search requester information may include a user identity, e.g. a user name, or a user identifier, e.g. a user address, or a user client identifier/identity, or any other user related information associated with the search requester.

Said at least one search criteria may comprise information about the data to be searched, e.g. special content of the data of special data types or any other data information, or it may comprise information about the data repositories where the search should be performed. Furthermore, in case that said communication system represents a group and list communication system, then said at least one search criteria may further comprise information about special groups and/or lists where the search should be performed.

Based on said extracted search related information, it can be determined whether a search request is to be intercepted or not.

According to an exemplary embodiment of the present invention, said search message is a search response and said at least one extracted search related information is at least one out of search requester information and at least one search content representative.

For instance, said search requester information may include a user identity, e.g. a user name, or a user identifier, e.g. a user address, or a user client identifier/identity, or any other user related information associated with the search requester.

Said at least one search content representative may comprise any content of the search response, e.g. data that has been found based on a search and/or data identifiers. Furthermore, in case that said communication system represents a group and list communication system, then said at least one search content representative may further comprise information about special groups and/or lists where the searched data has been found.

Based on said extracted search related information, it can be determined whether a search response is to be intercepted or not.

According to an exemplary embodiment of the present invention, said determining comprises comparing said at least one extracted search related information with at least one interception rule.

Said at least one interception rule may for instance contain a list of intercepted subjects including at least one person, specified in a lawful authorization, whose telecommunications are to be intercepted, and/or it may contain at least one kind of data, specified in a lawful authorization, indicating that a search into said kind of data is to intercepted, or any other criteria indicating that a search based on said criteria is to be intercepted. E.g., in case the communication system represents a group and list communication system, these other criteria may be for example at least one specified group and/or list of said communication system, e.g. a group associated with terrorists or the like.

Said at least one interception rule may be applied to determine whether at least one of said at least one search related information represents information to be intercepted, e.g. by checking if any of said at least one interception rule indicates that any of the extracted search related information represents search related information to be intercepted.

According to an exemplary embodiment of the present invention, at least one interception rule is received from a law enforcement agency, and said received at least one interception rule is stored in a storage entity.

For instance, said storage entity may represent an internal database in the communication system for storing said at least one interception rule. Said storage entity may be represent a separate network element, or it may be implemented in an existing network element of the communication system, e.g. in a search proxy. This storage entity may be connectable to the law enforcement agency via an interface in order to receive interception rules. Thus, said at least one interception rule used for performing lawful interception may be updated by the law enforcement agency. For instance, said interface may comprise an operator's administration function unity and a handover interface port in order to connect to a LEAMF of a law enforcement agency.

According to an exemplary embodiment of the present invention, said communication system is a group and list communication system, and said search message is associated with a search in at least one network repository in said group communication system.

Said at least one network repository may comprise at least one group storage entity, and/or at least one list storage entity, and/or at least one further storage entity.

For instance, said search message may represent a search request for performing a search in said at least one network repository, wherein said search request may be received from a search requester, e.g. a user or a user client.

Further, for instance, said search message may represent a search response intended to be transmitted to a search requester after a search into said at least one network repository has been performed.

Furthermore, for instance, said group and list communication may represent an XML document management system.

According to an exemplary embodiment of the present invention, said at least one network repository is at least one Extensible Markup Language document management server (XDMS).

For instance, said at least one XDMS may comprise at least one Shared Profile XDMS, and/or at least one Shared Group XDMS, and/or at least one Shared List XDMS, and/or at least one Enabler Specific XDMS, and/or at least one further XDMS.

According to an exemplary embodiment of the present invention, said extracting and determining is performed by at least one of said at least one network repository.

According to an exemplary embodiment of the present invention, said communication system comprises a network search element, wherein said extracting and determining is performed by said network search element.

Said network search element may represent a single contact point in the communication system for performing search activities in response to a search request. Thus, performing said extracting and determining by said network search element may show the advantage, that any search request has to pass the network search element and thus can easily checked whether it has be intercepted.

Furthermore, the network search element is configured to understand the query programming language in order to extract the search related information for performing the search. Thus, this extracting of the search related information can be also used for the present invention in order to obtain the search related information necessary for determining whether at least one of said at least one extracted search related information is to intercepted. For instance, said extracting may be performed by a parsing unit. Thus, this exemplary embodiment may show the advantage, that only one single parsing unit for the query programming language is necessary in the communication system. The same holds for search responses, which also have to pass the network search element.

According to an exemplary embodiment of the present invention, said network search element is a search proxy.

For instance, said search proxy may be a search proxy in an XML document management system and the query programming language may represent an XQuery language.

According to an exemplary embodiment of the present invention, said communication system comprises a network element which provides at least one contact point for clients of the communications system, and wherein said extracting, determining and sending is performed by said network element.

For instance, a search message is transmitted via one contact point of said at least one contact point to a client of the communication system, wherein said search message may represent a search response received from a separate search network element.

Further, for instance, a search message from a client of the communication system is received via one contact point of said at least one contact point, and said search message may be transmitted to a separate search network element in order to perform the search.

In this case, the network element providing at least one contact point for clients may comprise a parsing unit in order to extract said at least one search related information of said search messaging based on the query programming language.

Said network element may further be configured to communicate with a client or a user in order to transmit and/or receive content or information to/from said client or a user, e.g. content or information to be stored in at least a storage entity or content or information transmitted from at least one storage entity to the client or user. Said transmission of content may be based on protocol being different from the protocol used for search messages like search requests or search responses. E.g., in case the method is applied to the group and list communication system, e.g. an XML document management system, then the XCAP protocol may be used for transmitting content via a first contact point, and XQuery based on the XQuery programming language may be used for transmitting search messages via a second contact point.

According to an exemplary embodiment of the present invention, said network element is an aggregation proxy.

For instance, said aggregation proxy may be implemented in an XML document management system.

According to an exemplary embodiment of the present invention, said query programming language is an XQuery language.

This XQuery language may for instance be Limited Query over OMA-extended XCAP.

According to an exemplary embodiment of the present invention, said sending comprises sending the search message to the enforcement agency.

Thus, the whole search message is sent to the enforcement agency in case at least one of said at least one extracted search information is determined to be intercepted.

According to an exemplary embodiment of the present invention, said communication system may comprise at least one interface configured to communicate with said law enforcement agency.

For instance, the communication system may comprise a first interface comprising a handover interface port for receiving administrative information from a law enforcement agency. E.g. this first interface may be connected with a database including said at least one interception rule, so that these interception rules can be updated via this interface.

Furthermore, the communications system may comprise a second interface comprising a handover interface port for sending said at least one of said at least one search related information to the law enforcement agency.

These and other aspects of the invention will be apparent from and elucidated with reference to the detailed description presented hereinafter. The features of the present invention and of its exemplary embodiments as presented above are understood to be disclosed also in all possible combinations with each other.

### BRIEF DESCRIPTION OF THE FIGURES

In the figures show:

FIG. 1: An exemplary block diagram of a group and list communication system;

FIG. 2: a schematic block diagram of a traditional model for lawful interception;

FIG. 3: a schematic block diagram of an exemplary embodiment of a method according to the present invention;

FIG. 4: a schematic block diagram of a first exemplary embodiment of the present invention in a communication system;

FIG. 5: a schematic block diagram of a second exemplary embodiment of the present invention in a group and list communication system.

FIG. 6: a schematic block diagram of a third exemplary embodiment of the present invention in a group and list communication system.

FIG. 7: a schematic block diagram of a fourth exemplary embodiment of the present invention in a group and list communication system.

### DETAILED DESCRIPTION OF THE INVENTION

In the following detailed description of the present invention, exemplary embodiments of the present invention will be described in the context of lawful interception for search functionalities.

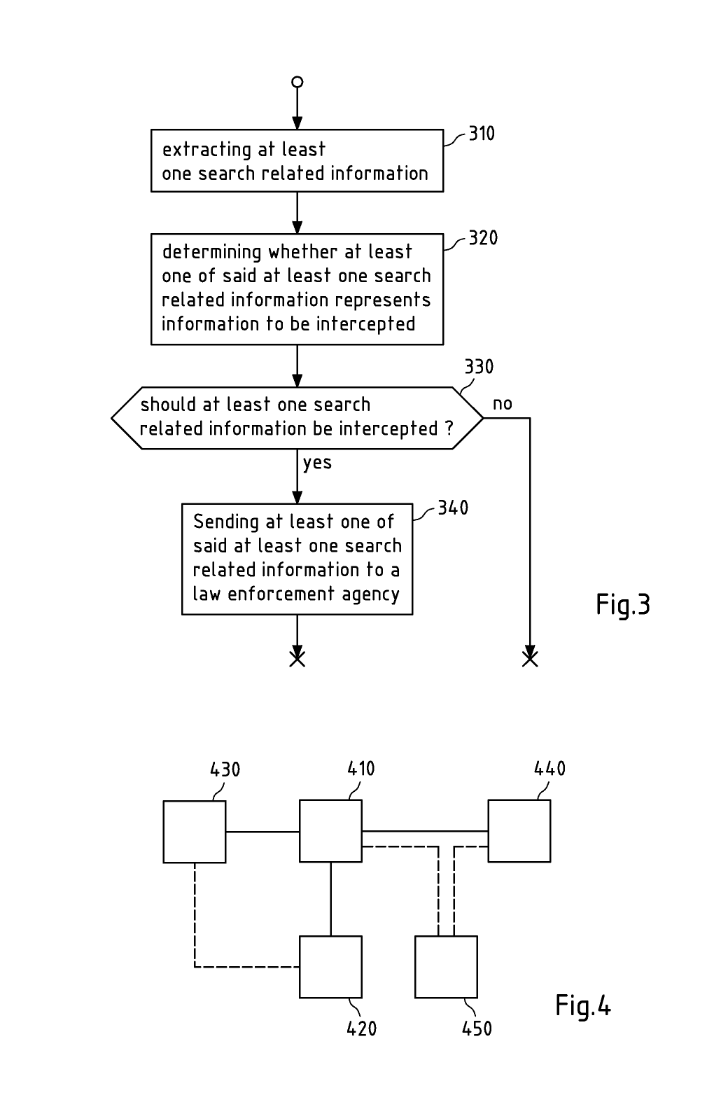

FIG. 3 depicts a schematic block diagram of an exemplary embodiment of a method according to the present invention.

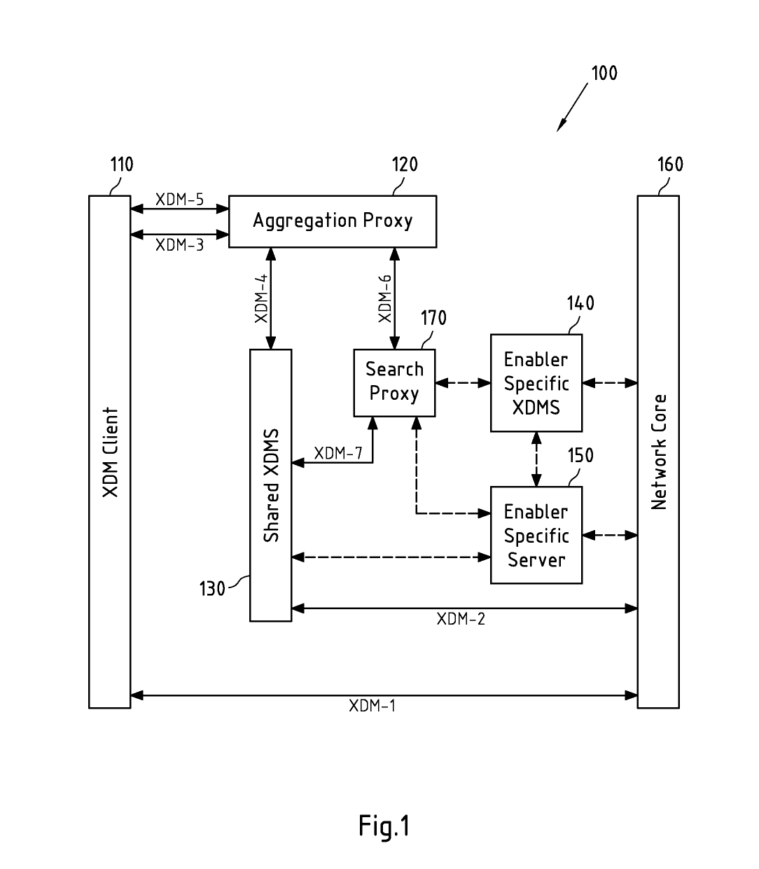

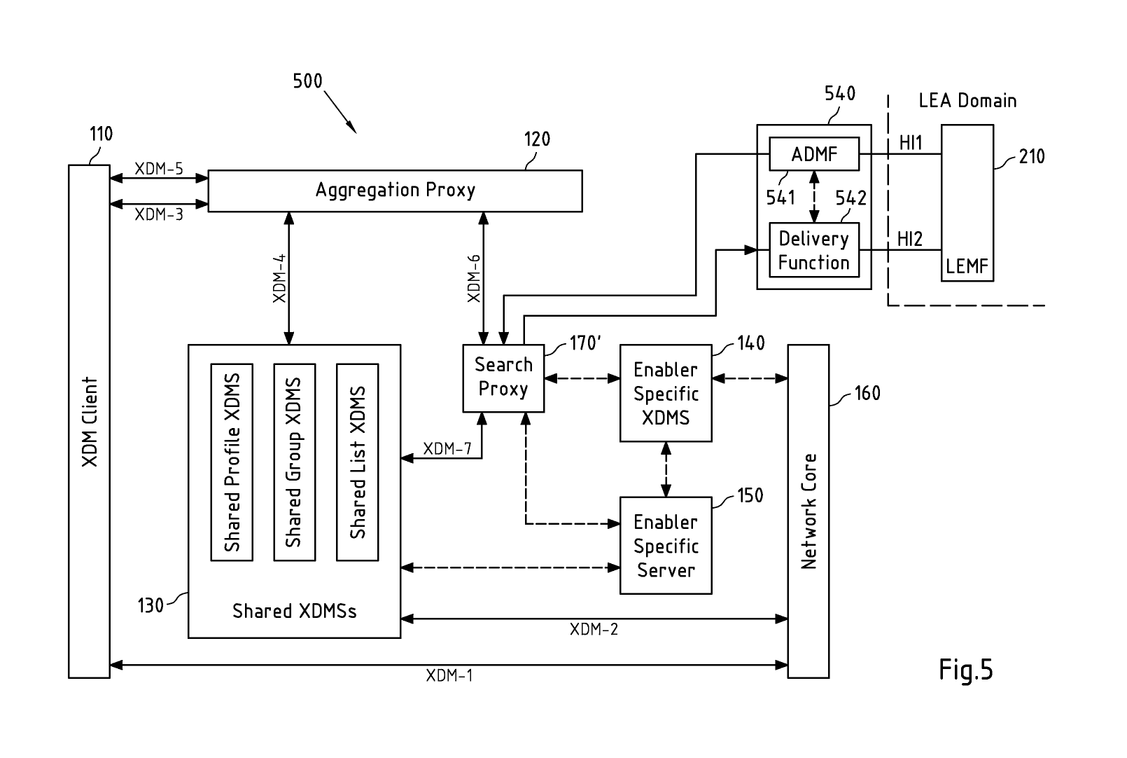

This exemplary embodiment of a method according to the present invention will be explained in view of the schematic block diagram of a first exemplary embodiment of the present invention in a communication system depicted in FIG. 4, and further with respect to the group and list communication system 100 depicted in FIG. 1.

The method depicted in FIG. 3 may be applied to any communication system such as depicted in FIG. 1 or FIG. 4 where search requests from a search requester, e.g. a user client 110 or a user, can be received in order to search into content or information stored or being accessible in said communication system according to rules defined in the search request. Said content or information may be stored in at least one storage entity, e.g. the at least one storage entity 420 depicted in FIG. 4 or in at least one XML document management server (XDMS) 130,140 depicted in FIG. 1. For instance, said at least one storage entity may be at least one logical repository in the network and/or at least one physical repository in the network.

Furthermore, the method depicted in FIG. 3 may also be applied to any communication system such as depicted in FIG. 1 or FIG. 4 where search responses to a search requester are transmitted, wherein such a search response contains content of response of a conducted search.

The search message, i.e. the search request or the search response, is based on a query programming language. For instance, said query programming language may be one out of SQL, MDX for OLAP (Online Analytical Processing) databases, DMX for Data Mining models and XQuery. Furthermore, the query programming language may be any other suited query language suited for search into databases and/or information systems.

For instance, a search request may be received in a communication system such as depicted in FIG. 1 or FIG. 4 from a search requester. E.g. this search request is received via a network element 120,430 which provides at least one contact point for clients or users of the communication system. Said network element 120,430 may further be configured to communicate with a client or a user in order to transmit and/or receive content to/from said client or a user, e.g. content to be stored in at least a storage entity 130,140,420 or content transmitted from at least one storage entity 130,140,420 to the client or user. Said transmission of content may be based on a protocol being different from the protocol used for search messages like search requests or search responses. E.g., in case the method is applied to the group communication system depicted in FIG. 1, the XCAP protocol may be used for transmitting content via the contact point XDM-3, and XQuery based on the XQuery programming language may be used for transmitting search messages via the contact point XDM-5.

Furthermore, the search may be performed by a network search element 170,410 in said communication system. For instance, said network search element 170,410 may represent a search proxy.

After receiving the search request, at least one search related information is extracted from said search message, i.e. the search request, as depicted in step 310 in FIG. 3. Said extraction is based on the query programming language in order to parse the language and to extract the search related information from the search request. Thus, said extracting may be performed by a parser corresponding to the applied query programming language. For instance, any search related information contained in a search request is extracted.

This search related information may be at least one out of search requester information and at least one search criteria. The search requester information may contain information about the search requester identity, e.g. a user identification. Said at least one search criteria may contain any information for performing the search in the communication system, e.g. special data to be searched and/or special data repositories to be searched and/or any other search criteria.

Based on the extraction of this search information, it is determined whether at least one of said at least one search related information represents information to be intercepted (step 320). This determining may be based on rules given by a lawful authorization.

For instance, the communication system such as depicted in FIG. 1 or FIG. 4 may optionally comprise an internal database 450 and/or storage entity containing at least one interception rule, wherein said at least one interception rule may be applied to determine whether at least one of said at least one search related information represents information to be intercepted. Said at least one interception rule may for instance contain a list of intercepted subjects including at least one person, specified in a lawful authorization, whose telecommunications are to be intercepted, and/or it may contain at least one kind of data, specified in a lawful authorization, indicating that a search into said kind of data is to be intercepted, or any other criteria indicating that a search based on said criteria is to be intercepted. E.g., in case the communication system represents a group communication system, these other criteria may be for example at least one specified group of said communication system, e.g. a group associated with terrorists or the like.

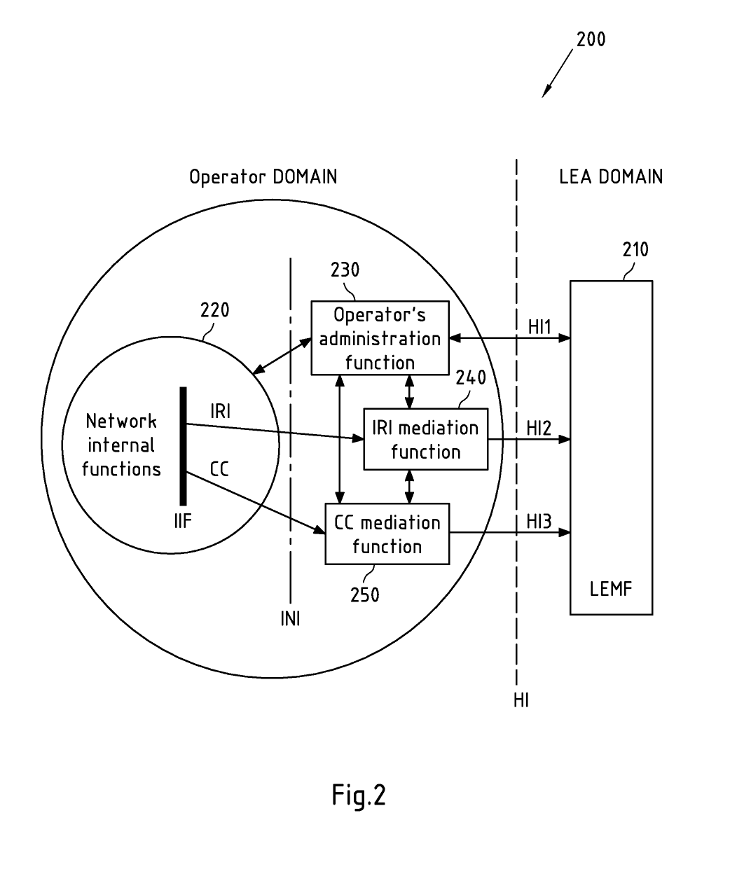

In case at least one of said at least one search related information represents information to be intercepted (step 330), then at least one of said at least one search related information is sent to a law enforcement agency (step 340). This sending may be performed by an interface 440, wherein this interface is configured to communicate with a corresponding law enforcement agency. For instance, said interface 440 may comprise the mediation function 240 and the handover interface port 2 (HI2) depicted in FIG. 2 in order to transmit said at least one of said at least one search related information to a law enforcement monitoring facility (LEMF) of a law enforcement agency (LEA).

Furthermore, the whole search request may be transmitted to the law enforcement agency in case that at least one of said at least one search related information represents information to intercepted.

The aforementioned explanations regarding the search request also hold for a search response. This search response may be transmitted to a search requester after a search has been conducted, e.g. based on a preceding search request. This search response contains content of response of said conducted search and is also based on the query programming language.

Based on the query programming language, at least one search related information is extracted from the search response (step 310). This search related information may be at least one out of a search requester information and at least one search content representative. The search requester information may contain information about the search requester identity, e.g. a user identification. The at least one search content representative may contain any content of the search response, e.g. data that has been found based on the search or data identifiers.

After said at least one search related information has been extracted, it is determined whether at least one of said at least one search related information represents information to be intercepted (step 320).

As mentioned above, this determining may be based on rules given by a lawful authorization.

In case at least one of said at least one search related information represents information to be intercepted (step 330), the at least one of said at least one search related information is transmitted to a law enforcement agency (step 340). This transmitting may be performed as explained above with respect to the search request. For instance, the whole search response may be transmitted to the law enforcement agency. Further, for instance, in case that the corresponding search request is available, then this corresponding search request may also be transmitted to the law enforcement agency along with the corresponding search response.

Furthermore, in case the optional storage entity 450 is used for storing said at least one interception rule, then this optional storage entity 450 may be connected to the interface 440 in order to be connected to a law enforcement agency. For instance, said interface 440 may comprise an operator's administration function unity 230 and a handover interface port 1 (HI1) in order to connect to a LEAMF of a law enforcement agency, as depicted in FIG. 2. Thus, the storage entity may receive interception rules from a law enforcement agency, e.g. in order to update the at least one interception rule. The present invention allows checking whether a search message based on a query programming language, e.g. a search request or a search response based on a query programming language, is to be intercepted. This checking can not be performed by network elements that do not understand the query programming language. Since a lot of communication systems use a protocol for transferring content being different from a query protocol, wherein this query protocol uses a query programming language, the checking whether a search message based on a query programming language is to be intercepted can not be performed by network elements which are only capable of applying the content transfer protocol, e.g. the XCAP protocol used in a group communication system. The present invention overcomes this problem, since it allows extracting the search related information from the search message based on the query programming language, e.g. an XQuery language used in a group and list communication system. For instance, this XQuery may be Limited XQuery over OMA-extended XCAP, which allows search of information from XML documents stored in any XMDS 130,140.

For instance, said extracting of at least one search related information (step 310) and said determining whether at least one of said at least one search related information represents information to be intercepted (step 320) may be performed by the network search element 410 depicted in FIG. 4. In this case, the network search element 410 is connected with the interface 440 in order to send said at least one of said at least one search related information to a law enforcement agency (step 340) in case at least one search related information is to be intercepted (step 330). Since the network search element 410 may be the single contact point for search requesters in order to perform a search into information, said performing the lawful interception in the network search element 410 shows the advantage, that any search request and any search response is available at the network search element 410 and can thus be easily checked. Furthermore, only one interface 440 connected with a single unit, i.e. the network search element 410, is necessary to communicate with a law enforcement agency. Further, the optionally storage entity 450 may be included in the network search element 410.

For instance, in case the communication system depicted in FIG. 4 represents a group and list communication system based on the system 100 depicted in FIG. 1, then the network search element 410 may correspond to the Search Proxy 170. Such a group communication system, wherein the Search Proxy 170 corresponds to the network search element 410 depicted in FIG. 4, is shown in FIG. 5.

FIG. 5 depicts a schematic block diagram of a second exemplary embodiment of the present invention in a group and list communication system 500, wherein said extracting of at least one search related information (step 310) and said determining whether at least one of said at least one search related information represents information to be intercepted (step 320) is performed by the Search Proxy 170′. The group communication system 500 is based on the group communication system 100 depicted in FIG. 1, thus the explanations mentioned above and mentioned in the background of the invention also hold for the group communication system 500 shown in FIG. 5.

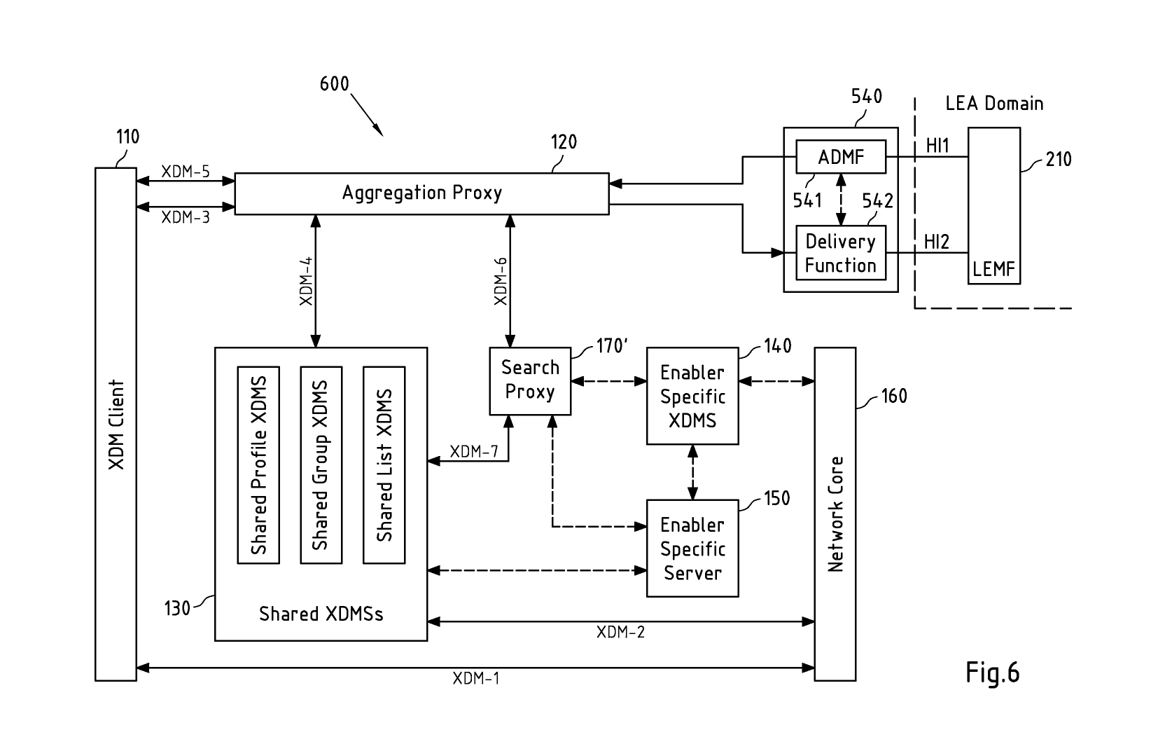

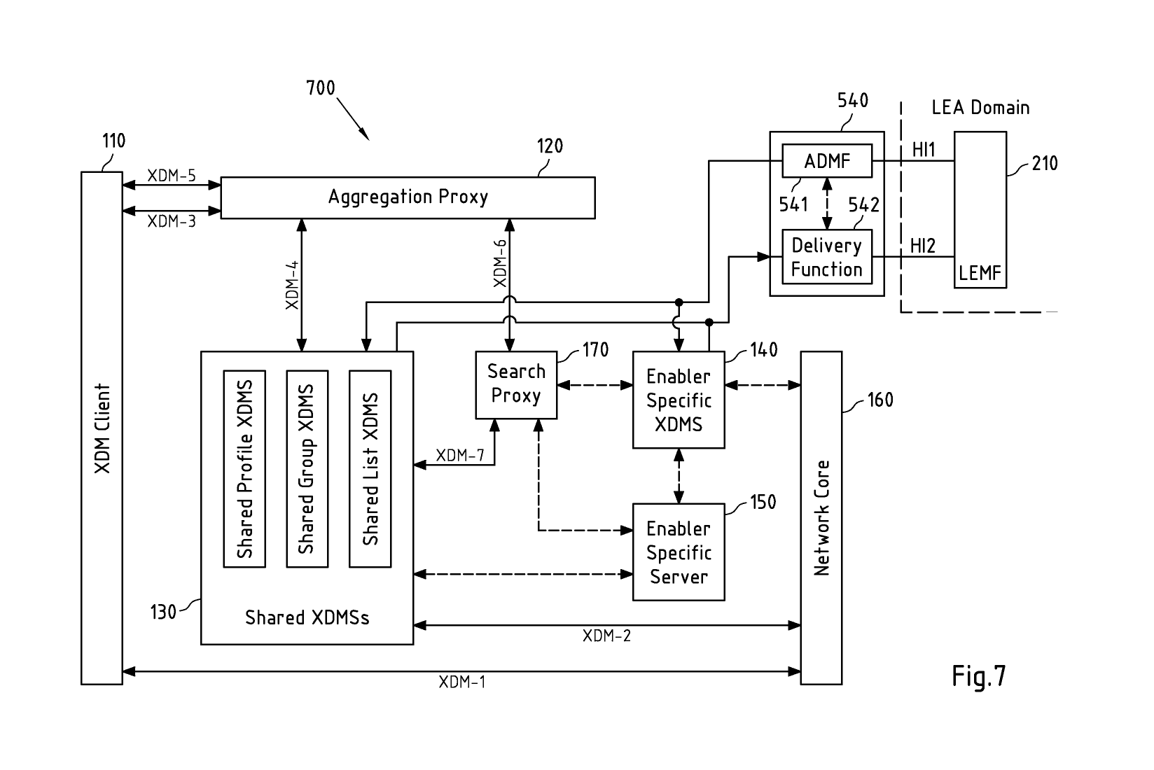

Furthermore, any explanations and advantages mentioned above with respect to the communications system dipicted in FIG. 4, the network search element 410 and the method depicted in FIG. 3 also hold for the group communication system 500 depicted in FIG. 5. The same holds for the group communication system 600 and 700 depicted in FIGS. 6 and 7, respectively.

The Search Proxy 170′ is connected to an interface 540 in order to send at least one of said at least one search related information to a law enforcement agency 210 via a delivery function 542 and a handover interface (HI2). The delivery function 542 may further include a mediation function. Furthermore, the delivery function 542 may correspond to the IRI (intercept-related information) mediation function 240 depicted in FIG. 2.

Furthermore, the Search Proxy 170′ may comprise a database comparable to the storage entity 450 depicted in FIG. 4 in order to store at least one interception rule. This database may be updated by a law enforcement agency 210 via the administrative function 541 of the interface 540 and the corresponding handover interface port 1 (HI1). The administrative function 541 may further include a mediation function. Furthermore, the administrative function 541 may correspond to the operator's administration function 230 depicted in FIG. 2.

Thus, the group communication system 500 allows for checking whether incoming XQquery requests received via contact point XDM-5 and passed through the aggregation proxy 120 to the Search Proxy 170′ are to be intercepted as aforementioned in view of the method depicted in FIG. 3. It is not possible to perform this checking by the aggregation proxy 120, since the aggregation proxy 120 does not understand XQuery language. Since the Search Proxy 170′ understands the XQuery language, the method of the present invention can be implemented very efficiently in the Search Proxy 170′.

Furthermore, the group communication system 500 also allows checking whether outgoing XQuery responses are to be intercepted as aforementioned in view of the method depicted in FIG. 3.

Alternatively, said extracting of at least one search related information (step 310) and said determining whether at least one of said at least one search related information represents information to be intercepted (step 320) may be performed by the network element 430 which provides at least one contact point for clients depicted in FIG. 4. In this case, the network element 430 is connected to the interface 440 in order to communicate with a law enforcement agency, and the network element 430 may be connected to or may comprise the storage entity 450.

Correspondingly, the group communication system 500 depicted in FIG. 5 may be modified in a similar way, so that said extracting of at least one search related information (step 310) and said determining whether at least one of said at least one search related information represents information to be intercepted (step 320) is not performed by the Search Proxy 170 but by the Aggregation Proxy 120, as depicted in the group communication system 600 in FIG. 6. In this case, the Aggregation Proxy 120 is connected to the interface 540 in order to communicate with a law enforcement agency, and the network element 430 may be connected to or may comprise a database for storing at least one interception rule. Thus, a parser for parsing XQuery language may be implemented in the Aggregation Proxy 120 in order to extract said at least one search related information from a search message like an XQuery request or XQuery response, since the original Aggregation Proxy 120 of an XDM system depicted in FIG. 1 does not understand XQuery language.

Furthermore, as another alternative, said extracting of at least one search related information (step 310) and said determining whether at least one of said at least one search related information represents information to be intercepted (step 320) may be performed by at least one of the at least one content storage entity 420. In this case, said at least one of said at least one content storage entity 420 is connected to the interface 440 in order to communicate with a law enforcement agency, and said at least one of said at least one content storage entity 420 may be connected to or may comprise the storage entity 450.

Correspondingly, the group communication system 500 depicted in FIG. 5 may be modified in a similar way, so that said extracting of at least one search related information (step 310) and said determining whether at least one of said at least one search related information represents information to be intercepted (step 320) is not performed by the Search Proxy 170 but by the XDMS Servers 130,140, as depicted in the group communication system in FIG. 7. In this case, the XDM Servers 130,140 are connected to the interface 540 in order to communicate with a law enforcement agency, and the XDM Servers 130,140 may be connected to or may comprise a database for storing at least one interception rule.

It should be realized that the various apparatuses, programs, methods and systems disclosed above may be carried out by a variety of means besides those explicitly shown. For instance, any kind of apparatus (not just those shown in FIGS. 4-7) can be provided with components that take the form of various means for carrying out the method of FIG. 3. As such, an apparatus or system according to the invention may include means for extracting at least one search related information from a search message in a communication system, wherein said search message is based on a query programming language and is associated with a search requester, and wherein said search message is one out of a search request and a search response. It may also include means for determining whether at least one of said at least one search related information represents information to be intercepted. Finally, it may also include means for sending at least one of said at least one search related information to a law enforcement agency in case at least one of said at least one search related information represents information to be intercepted. In the case of a system, these various means may be distributed among different entities or network elements.

The invention has been described above by means of exemplary embodiments. It should be noted that there are alternative ways and variations which are obvious to a skilled person in the art and can be implemented without deviating from the scope and spirit of the appended claims. In the claims, means-plus-function clauses are intended to cover the structures described herein as performing the recited function and not only structural equivalents, but also equivalent structures.

Furthermore, it is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electro-magnetic or optic type and may be read and executed by a processor, such as for instance a microprocessor. To this end, the processor and the storage medium may be coupled to interchange information, or the storage medium may be included in the processor.

What is claimed is:

1. A method, comprising:
extracting at least one search related information from a search message in a communication system, wherein said search message is based on a query programming language and is associated with a search requester, and wherein said search message is one out of a search request and a search response;
determining whether at least one of said at least one search related information represents information to be intercepted;
sending at least one of said at least one search related information to a law enforcement agency in case at least one of said at least one search related information represents information to be intercepted.

2. The method of claim 1, wherein said search message is a search request and said at least one extracted search related information is at least one out of:
search requester information;
at least one search criteria;

3. The method of claim 1, wherein said search message is a search response and said at least one extracted search related information is at least one out of:
search requester information;
at least one search content representative;

4. The method of claim 1, wherein said determining comprises comparing said at least one extracted search related information with at least one interception rule.

5. The method of claim 4, further comprising:
receiving at least one interception rule from a law enforcement agency.
storing said received at least one interception rule in a storage entity.

6. The method of claim 1, wherein said communication system is a group and list communication system, and wherein said search message is associated with a search in at least one network repository in said group communication system.

7. The method of claim 6, wherein said at least one network repository is at least one Extensible Markup Language document management server.

8. The method of claim 6, wherein said extracting and determining is performed by at least one of said at least one network repository.

9. The method of claim 6, wherein said group and list communication system comprises a network search element, and wherein said extracting and determining is performed by said network search element.

10. The method of claim 9, wherein said network search element is a search proxy.

11. The method of claim 6, wherein said communication system comprises a network element which provides at least one contact point for clients of the communications system, and wherein said extracting and determining is performed by said network element.

12. The method of claim 11, wherein said network element is an aggregation proxy.

13. The method of claim 1, wherein said query programming language is an XQuery language.

14. The method of claim 1, wherein said sending comprises sending the search message to the enforcement agency.

15. A computer-readable medium having a computer program stored thereon, the computer program comprising:
extracting at least one search related information from a search message in a communication system, wherein said search message is based on a query programming language and is associated with a search requester, and wherein said search message is one out of a search request and a search response;
determining whether at least one of said at least one search related information represents information to be intercepted;
sending at least one of said at least one search related information to a law enforcement agency in case at least one of said at least one search related information represents information to be intercepted.

16. The computer-readable medium according to claim 15, wherein said determining comprises comparing said at least one extracted search related information with at least one interception rule.

17. An apparatus, comprising a processing component configured to:
extract at least one search related information from a search message in a communication system, wherein said search message is based on a query programming language and is associated with a search requester, and wherein said search message is one out of a search request and a search response;
determine whether at least one of said at least one search related information represents information to be intercepted; and
send at least one of said at least one search related information to a law enforcement agency in case at least one of said at least one search related information represents information to be intercepted.

18. The apparatus of claim 17, wherein said search message is a search request and said at least one extracted search related information is at least one out of:
search requester information;
at least one search criteria;

19. The apparatus of claim 18, wherein said search message is a search response and said at least one extracted search related information is at least one out of:
search requester information;
at least one search content representative;

20. The apparatus of claim 17, wherein said determining comprises comparing said at least one extracted search related information with at least one interception rule.

21. The apparatus of claim 20, wherein said processing component is configured to:
receive at least one interception rule from a law enforcement agency.
store said received at least one interception rule in a storage entity.

22. The apparatus of claim 17, wherein said communication system is a group and list communication system, and wherein said search message is associated with a search in at least one network repository in said group communication system.

23. The apparatus of claim 22, wherein said at least one network repository is at least one Extensible Markup Language document management server.

24. The apparatus of claim 21, wherein said apparatus represents a network search element.

25. The apparatus of claim 24, wherein said network search element is a search proxy.

26. The apparatus of claim 22, wherein said apparatus represents a network element which provides at least one a contact point for clients of the communications system.

27. The apparatus of claim 25, wherein said network element is an aggregation proxy.

28. The apparatus of claim 17, wherein said query language is an XQuery programming language.

29. The apparatus of claim 17, wherein said sending comprises sending the search message to said law enforcement agency.

30. A system comprising:
an apparatus according to claim 17,
at least one interface configured to connect at least one user to said system, and
at least one interface configured to communicate with a law enforcement agency.

31. The system according to claim 30, wherein said determining comprises comparing said at least one extracted search related information with at least one interception rule, and wherein the system comprises a storage entity for storing said at least one interception rule.

32. The system according to claim 30, wherein said system is a group and list communication system comprising at least one network repository, and wherein said search message is associated with a search in at least one of said at least one network repository.

33. An apparatus, comprising
means for extracting at least one search related information from a search message in a communication system, wherein said search message is based on a query programming language and is associated with a search requester, and wherein said search message is one out of a search request and a search response;
means for determining whether at least one of said at least one search related information represents information to be intercepted;
means for sending at least one of said at least one search related information to a law enforcement agency in case at least one of said at least one search related information represents information to be intercepted.
